(19) United States
(12) Patent Application Publication
(10) Pub. No.: US 2014/0018475 A1
(43) Pub. Date: Jan. 16, 2014

(54) HIGH GLASS TRANSITION TEMPERATURE THERMOSET AND METHOD OF MAKING THE SAME

(71) Applicants: Joshua C. Falkner, Richmond, TX (US); Soma Chakraborty, Houston, TX (US); Radhika Suresh, Sugar Land, TX (US)

(72) Inventors: Joshua C. Falkner, Richmond, TX (US); Soma Chakraborty, Houston, TX (US); Radhika Suresh, Sugar Land, TX (US)

(73) Assignee: BAKER HUGHES INCORPORATED, Houston, TX (US)

(21) Appl. No.: 13/549,626

(22) Filed: Jul. 16, 2012

(51) Int. Cl. C08G 59/14; C08K 3/34; C08L 27/18; C08K 3/36; C08K 3/04; C08K 3/30

(52) U.S. Cl. CPC C08G 59/1438; C08K 3/04; C08K 3/30; C08L 27/18; C08K 3/36; C08K 3/346
USPC 523/458; 525/523; 523/468; 525/187; 523/466

(57) ABSTRACT

A process for preparing a nanocomposite includes combining a resin and silsesquioxane; introducing a curing agent to the resin and silsesquioxane to form a composition; and forming a reaction product of the composition to prepare the nanocomposite, wherein a total amount of the silsesquioxane and curing agent in the composition is from 1 wt % to 70 wt %, based on a weight of the composition. Additionally, a process for preparing an article includes combining an epoxy resin and silsesquioxane; introducing a curing agent to the epoxy resin and silsesquioxane to form a composition; and reacting the epoxy resin, silsesquioxane, and curing agent to form the nanocomposite, wherein a molar ratio of a number of moles of an epoxy functional group of the epoxy resin to the sum of the number of moles of the silsesquioxane and curing agent is from 1:1 to 100:1. An article includes the reaction product of the resin, silsesquioxane, and curing agent.

### BACKGROUND

To improve properties of polymers, bulk materials are sometimes added to a polymer matrix. However, some of these bulk materials also diminish performance characteristics or introduce unfavorable properties, for example, premature degradation of the polymer. Balancing the need for more robust polymer compositions with available bulk materials has proved challenging. Thus, new materials and methods to improve polymer material performance would be well received in the art.

### BRIEF DESCRIPTION

The above and other deficiencies of the prior art are overcome by, in an embodiment, a process for preparing a nanocomposite, the process comprising: combining a resin and silsesquioxane; introducing a curing agent to the resin and silsesquioxane to form a composition; and forming a reaction product of the composition to prepare the nanocomposite, wherein a total amount of the silsesquioxane and curing agent in the composition is from 1 wt % to 70 wt %, based on a weight of the composition.

In another embodiment, a process for preparing an article comprises: combining an epoxy resin and silsesquioxane; introducing a curing agent to the epoxy resin and silsesquioxane to form a composition; and reacting the epoxy resin, silsesquioxane, and curing agent to form the nanocomposite, wherein a molar ratio of a number of moles of an epoxy functional group of the epoxy resin to the sum of the number of moles of the silsesquioxane and curing agent is from 1:1 to 100:1.

In a further embodiment, an article comprises a reaction product of: an epoxy resin; a silsesquioxane; and a curing agent, wherein a total amount of the silsesquioxane and curing agent is from 1 wt % to 70 wt %, based on a total weight of the polymer, silsesquioxane, and curing agent.

### BRIEF DESCRIPTION OF THE DRAWINGS

The following descriptions should not be considered limiting in any way. With reference to the accompanying drawings, like elements are numbered alike:

FIG. 1 shows a graph of storage modulus versus temperature for various compositions; and

FIG. 2 shows another graph of storage modulus versus temperature for various compositions.

### DETAILED DESCRIPTION

A detailed description of one or more embodiments is presented herein by way of exemplification and not limitation.

It has been found that a nanocomposite having a reaction product of resin, nanofiller, and curing agent exhibits an increased glass transition temperature as compared to the native resin or the resin crosslinked by a curing agent without nanofiller. The nanofiller is compatible with and interacts with the resin such that the nanofiller easily disperses in the resin. In addition, a synergistic effect of a certain relative amount of the nanofiller, curing agent, and resin enhances performance and properties of the nanocomposite such as storage modulus.

In an embodiment, the nanocomposite is prepared by combining a resin and a nanofiller, e.g., silsesquioxane. A curing agent is introduced to the resin and silsesquioxane to form a composition, and a reaction product of the composition is formed to prepare the nanocomposite. A total amount of the silsesquioxane and curing agent in the composition is from 1 weight percent (wt %) to 70 wt %, based on a weight of the composition.

Silsesquioxanes, also referred to as polysilsesquioxanes, polyorganosilsesquioxanes, or polyhedral oligomeric silsesquioxanes (POSS), are polyorganosilicon oxide compounds of general formula RSiO_{1.5} (where R is a hydrogen, inorganic group, or organic group) having defined closed or open cage structures (closo or nido structures, which are called respectively completely condensed or incompletely structures). Silsesquioxanes can be prepared by acid and/or base-catalyzed condensation of functionalized silicon-containing monomers such as tetraalkoxysilanes including tetramethoxysilane and tetraethoxysilane, alkyltrialkoxysilanes such as methyltrimethoxysilane and methyltrimethoxysilane, as well as other groups.

In an embodiment, the silsesquioxane has a closed cage structure, an open cage structure, or a combination comprising at least one of the foregoing. The silsesquioxane can have any shape of cage structure such as cubes, hexagonal prisms, octagonal prisms, decagonal prisms, dodecagonal prisms, and the like. Additionally, the cage structure of the silsesquioxane comprises from 4 to 30 silicon atoms, specifically, 4 to 20 silicon atoms, and more specifically 4 to 16 silicon atoms, with each silicon atom in the cage structure being bonded to oxygen. It should be noted that the term “cage structure” is meant to include the SiO_{1.5} portion of the general silsesquioxane formula RSiO1.5, and not the R-group.

Nanoparticles, from which the nanofiller is formed, are generally particles having an average particle size, in at least one dimension, of less than one micrometer (μm). As used herein “average particle size” refers to the number average particle size based on the largest linear dimension of the particle (sometimes referred to as “diameter”). Particle size, including average, maximum, and minimum particle sizes, may be determined by an appropriate method of sizing particles such as, for example, static or dynamic light scattering (SLS or DLS) using a laser light source. Nanoparticles may include both particles having an average particle size of 250 nm or less, and particles having an average particle size of greater than 250 nm to less than 1 μm (sometimes referred in the art as “sub-micron sized” particles). In an embodiment, a nanoparticle may have an average particle size of about 0.1 nanometers (nm) to about 500 nm, specifically 0.5 nm to 250 nm, more specifically about 1 nm to about 150 nm, more specifically about 1 nm to about 125 nm, and still more specifically about 1 nm to about 75 nm. The nanoparticles may be monodisperse, where all particles are of the same size with little variation, or polydisperse, where the particles have a range of sizes and are averaged. Generally, polydisperse nanoparticles are used. Nanoparticles of different average particle size may be used, and in this way, the particle size distribution of the nanoparticles may be unimodal (exhibiting a single size distribution), bimodal exhibiting two size distributions, or multi-modal, exhibiting more than one particle size distribution.

The minimum particle size for the smallest 5 percent of the nanoparticles may be less than 2 nm, specifically less than or equal to 1 nm, and more specifically less than or equal to 0.5 nm. Similarly, the maximum particle size for 95% of the nanoparticles can be greater than or equal to 900 nm, specifically greater than or equal to 750 nm, and more specifically greater than or equal to 500 nm. The nanoparticles can have a high surface area of greater than 300 m²/g, and in a specific embodiment, 300 m²/g to 1800 m²/g, specifically 500 m²/g to 1500 m²/g. In a particular embodiment, the silsesquioxane has a size from 0.5 nm to 10 nm.

In an embodiment, an additional, second nanoparticle can be added to the silsesquioxane. The second nanoparticle comprises nanographite, nanographene, graphene fiber, or combinations comprising at least one of the foregoing. Nanographite is a cluster of plate-like sheets of graphite, in which a stacked structure of one or more layers of graphite, which has a plate-like two dimensional structure of fused hexagonal rings with an extended delocalized π-electron system, are layered and weakly bonded to one another through π-π stacking interaction. Nanographite has both micro- and nano-scale dimensions, such as for example an average particle size of 1 to 20 μm, specifically 1 to 15 μm, and an average thickness (smallest) dimension in nano-scale dimensions, and an average thickness of less than 1 μm, specifically less than or equal to 700 nm, and still more specifically less than or equal to 500 nm.

In an embodiment, the second nanoparticle is a graphene including nanographene and graphene fibers (i.e., graphene particles having an average largest dimension of greater than 1 mm and an aspect ratio of greater than 10, where the graphene particles form an interbonded chain). Graphene and nanographene, as disclosed herein, are effectively two-dimensional particles of nominal thickness, having of one or more layers of fused hexagonal rings with an extended delocalized π-electron system, layered and weakly bonded to one another through π-π stacking interaction. Graphene in general, including nanographene, can be a single sheet or a stack of several sheets having both micro- and nano-scale dimensions, such as in some embodiments an average particle size of 1 to 20 μm, specifically 1 to 15 μm, and an average thickness (smallest) dimension in nano-scale dimensions of less than or equal to 50 nm, specifically less than or equal to 25 nm, and more specifically less than or equal to 10 nm. An exemplary nanographene can have an average particle size of 1 to 5 μm, and specifically 2 to 4 μm. In addition, smaller nanoparticles or sub-micron sized particles as defined above may be combined with nanoparticles having an average particle size of greater than or equal to 1 μm. In a specific embodiment, the second nanoparticle is a nanographene.

Graphene can be prepared by exfoliation of graphite or by a synthetic procedure by “unzipping” a nanotube to form a nanographene ribbon, followed by derivatization of the nanographene to prepare, for example, nanographene oxide.

Exfoliation to form graphene or nanographene can be carried out by exfoliation of a graphite source such as graphite, intercalated graphite, and nanographite. Exemplary exfoliation methods include, but are not limited to, fluorination, acid intercalation, acid intercalation followed by thermal shock treatment, and the like, or a combination comprising at least one of the foregoing. Exfoliation of the nanographite provides a nanographene having fewer layers than non-exfoliated nanographite. It will be appreciated that exfoliation of nanographite can provide the nanographene as a single sheet only one molecule thick, or as a layered stack of relatively few sheets. In an embodiment, exfoliated nanographene has fewer than 50 single sheet layers, specifically fewer than 20 single sheet layers, specifically fewer than 10 single sheet layers, and more specifically fewer than 5 single sheet layers.

In an embodiment, the silsesquioxane or second nanoparticle can be derivatized to include functional groups such as, for example, epoxy, ether, ketone, alkaryl, lactone, alkyl, alkoxy, haloakyl, cycloalkyl, heterocycloalkyl, cycloalkyloxy, aryl, aralkyl, aryloxy, aralkyloxy, heteroaryl, heteroaralkyl, alkenyl, alkynyl, amine, alkyleneamine, aryleneamine, alkenyleneamine, hydroxy, carboxy (e.g., a carboxylic acid group or salt), halogen, hydrogen, or a combination comprising at least one of the forgoing functional groups. The silsesquioxane or second nanoparticles can be derivatized to introduce chemical functionality to the nanoparticle. For example, for nanographene, the surface and/or edges of the nanographene sheet is derivatized to increase dispersibility in and interaction with a resin matrix. In an embodiment, the derivatized silsesquioxane or second nanoparticle can be hydrophilic, hydrophobic, oxophilic, lipophilic, or may possess a combination of these properties to provide a balance of desirable net properties, by use of different functional groups.

The silsesquioxane or second nanoparticle can be derivatized by, for example, amination to include amine groups, where amination may be accomplished by nitration followed by reduction, or by nucleophilic substitution of a leaving group by an amine, substituted amine, or protected amine, followed by deprotection as necessary. In another embodiment, a silsesquioxane or second nanoparticle, e.g., nanographene, can be derivatized by oxidative methods to produce an epoxy, hydroxy group or glycol group using a peroxide, or as applicable by cleavage of a double bond by for example a metal mediated oxidation such as a permanganate oxidation to form ketone, aldehyde, or carboxylic acid functional groups.

Where the functional groups are alkyl, aryl, aralkyl, alkaryl, or a combination of these groups, the functional groups can be attached directly to the derivatized silsesquioxane or second nanoparticle by a carbon-carbon bond (or carbon-silicon bond for silsesquioxanes) without intervening heteroatoms, to provide greater thermal and/or chemical stability, to the derivatized first or second nanoparticle, as well as a more efficient synthetic process requiring fewer steps; by a carbon-oxygen (or silicon-oxygen for silsesquioxanes) bond (where the silsesquioxane or second nanoparticle contains an oxygen-containing functional group such as hydroxy or carboxylic acid); or by a carbon-nitrogen (or silicon-nitrogen for silsesquioxanes) bond (where the silsesquioxane or second nanoparticle contains a nitrogen-containing functional group such as amine or amide). In an embodiment, the silsesquioxane or second nanoparticle can be derivatized by metal mediated reaction with a C₆₋₃₀ aryl or C₇₋₃₀ aralkyl halide (F, Cl, Br, I) in a carbon-carbon (or silicon-carbon) bond forming step, such as by a palladium-mediated reaction such as the Stille reaction, Suzuki coupling, or diazo coupling, or by an organocopper coupling reaction. In another embodiment, a silsesquioxane or second nanoparticle, such as a graphene, can be directly metallated by reaction with, e.g., an alkali metal such as lithium, sodium, or potassium, followed by reaction with a C₁₋₃₀ alkyl or C₇₋₃₀ alkaryl compound with a leaving group such as a halide (Cl, Br, I) or other leaving group (e.g., tosylate, mesylate, etc.) in a carbon-carbon bond forming step. The aryl or aralkyl halide, or the alkyl or alkaryl compound, can be substituted with a functional group such as hydroxy, carboxy, ether, or the like. Exemplary groups include, for example, hydroxy groups, carboxylic acid groups, alkyl groups such as methyl, ethyl, propyl, butyl, pentyl, hexyl, octyl, dodecyl, octadecyl, and the like; aryl groups including phenyl and hydroxyphenyl; aralkyl groups such as benzyl groups attached via the aryl portion, such as in a 4-methylphenyl, 4-hydroxymethylphenyl, or 4-(2-hydroxyethyl)phenyl (also referred to as a phenethylalcohol) group, or the like, or aralkyl groups attached at the benzylic (alkyl) position such as found in a phenylmethyl or 4-hydroxyphenyl methyl group, at the 2-position in a phenethyl or 4-hydroxyphenethyl group, or the like. In an exemplary embodiment, the derivatized second nanoparticle is graphene substituted with a benzyl, 4-hydroxybenzyl, phenethyl, 4-hydroxyphenethyl, 4-hydroxymethylphenyl, 4-(2-hydroxyethyl)phenyl group, or a combination comprising at least one of the foregoing groups. In some embodiments, the second nanoparticle is an oxide of graphene or nanographite.

According to an embodiment, the silsesquioxane comprises a functional group bonded to a silicone atom of the silsesquioxane. In a specific embodiment, the functional group bonded to the silicon atom comprises an alkyl, alkoxy, haloakyl, cycloalkyl, heterocycloalkyl, cycloalkyloxy, aryl, aralkyl, aryloxy, aralkyloxy, heteroaryl, heteroaralkyl, alkenyl, alkynyl, amine, alkyleneamine, aryleneamine, alkenyleneamine, hydroxy, carboxyl, ether, epoxy, ketone, halogen, hydrogen, or combination comprising at least one of the foregoing. Thus, the silsesquioxane derivatized with a functional group includes a group such as an alcohol, amine, carboxylic acid, epoxy, ether, fluoroalkyl, halide, imide, ketone, methacrylate, acrylate, silica, nitrile, norbornenyl, olefin, polyethylene glycol (PEG), silane, silanol, sulfonate, thiol, and the like. Furthermore, the silsesquioxane can have from one functional group to as many functional groups as there are silicon atoms in the cage structure of the silsesquioxane. In a specific embodiment, the silsesquioxane is a derivatized octasilsesquioxane R₈₋ₙHₙ(SiO_{1.5})₈ (where 0≦n≦8, and R can be a same or different functional group), and the number of functional groups varies with the number of silicon atoms in the cage structure, i.e., from 0 to 8 functional groups.

Exemplary silsesquioxanes having a closed cage structure include 1-allyl-3,5,7,9,11,13,15-heptacyclopentylpentacyclo [9.5.1.1 (3,9).1 (5,15).1 (7,13)]octasiloxane; 1-allyl-3,5,7,9,11,13,15-heptaisobutylpentacyclo[9.5.1.1 (3,9).1 (5,15).1(7,13)]octasiloxane; 1-[3-(2-aminoethyl)amino]propyl-3,5,7,9,11,13,15-isobutylpentacyclo[9.5.1.1(3,9).1(5,15).1(7,13)]octasiloxane; 1-chlorobenzylethyl-3,5,7,9,11,13,15-heptaisobutylpentacyclo[9.5.1.1(3,9). 1(5,15).1 (7,13)]octasiloxane; 1-(4-chlorobenzyl)-3,5,7,9,11,13,15-heptacyclopentylpentacyclo[9.5.1.1(3,9).1(5,15).1(7,13)]octasiloxane; 1-chloropropyl-3,5,7,9,11,13,15-isobutylpentacyclo[9.5.1.1 (3,9).1(5,15). 1(7,13)]octasiloxane; (cyanopropyldimethylsilyloxy)heptacyclopentylpentacyclooctasiloxane; 1-(2-trans-cyclohexanedioDethyl-3,5,7,9,11,13,15-isobutylpentacyclo[9.5.1.1(3,9).1(5,15).1(7,13)]octasiloxane; 1-(3-cyclohexen-1-yl)-3,5,7,9,11,13,15-heptacyclopentylpentacyclo[9.5.1.1 (3,9).1 (5,15).1 (7,13)]octasiloxane; dodecaphenyl-dodecasiloxane; 1-[2-(3,4-epoxycyclohexyl)ethyl]-3,5,7,9,11,13,15-isobutylpentacyclo[9.5.1.1(3,9). 1(5,15).1 (7,13)]octasiloxane; 1,3,5,7,9,11,13-heptacyclopentyl-15-glycidylpentacyclo[9.5.1.1 (3,9).1 (5,15). 1 (7,13)]octasiloxane; 1-(3-glycidyl)propoxy-3,5,7,9,11,13,15-isobutylpentacyclo[9.5.1.1(3,9).1(5,15).1(7,13)]octasiloxane; octakis(tetramethylammonium) pentacyclo[9.5.1.1 (3,9).1 (5,15).1 (7,13)]octasiloxane-1,3,5,7,9,11,13,15-octakis(yloxide) hydrate; 3-hydroxypropylheptaisobutyl-octasiloxane; 1-(3-mercapto)propyl-3,5,7,9,11,13,15-isobutylpentacyclo[9.5.1.1(3,9).1(5,15).1(7,13)]octasiloxane; octacyclohexenylethyldimethylsilyloxy-octasiloxane; 1,3,5,7,9,11,13,15-octacyclohexylpentacyclooctasiloxane; octa[(1,2-epoxy-4-ethylcyclohexyl)dimethylsiloxy]octasiloxane; octa[(3-glycidyloxypropyl)dimethylsiloxy]octasiloxane; octa[(3-hydroxypropyl)dimethylsiloxy]octasiloxane; 1,3,5,7,9,11,13,15-octakis[2-(chlorodimethylsilyl)ethyl]pentacyclo[9.5.1.1(3,9).1(5,15).1 (7,13)]octasiloxane; 1,3,5,7,9,11,13,15-octakis(dimethylsilyloxy)pentacyclo[9.5.1.1 (3,9).1(5,15).1(7,13)]octasiloxane; 1,3,5,7,9,11,13,15-octamethylpentacyclo[9.5.1.1(3,9).1(5,15). 1(7,13)]octasiloxane; 1,3,5,7,9,11,13,15-octaphenylpentacyclo[9.5.1.1 (3,9).1 (5,15).1(7,13)]octasiloxane; 1,3,5,7,9,11,13,15-octa(2-trichlorosilyl)ethyl)pentacyclo[9.5.1.1(3,9).1(5,15).1 (7,13)]octasiloxane; 1,3,5,7,9,11,13,15-octavinylpentacyclo[9.5.1.1(3,9).1(5,15). 1(7,13)] octasiloxane; 1-(2,3-propanediol)propoxy-3,5,7,9,11,13,15-isobutylpentacyclo-[9.5.1.1 (3,9).1(5,15).1(7,13)]octasiloxane; 3-(3,5,7,9,11,13,15-heptaisobutylpentacyclo[9.5.1.1(3,9). 1(5,15).1 (7,13)]octasiloxan-1-yl)propylmethacrylate; (3-to syloxypropyl)-heptaisobutyloctasiloxane; 1-(trivinylsilyloxy)-3,5,7,9,11,13,15-heptacyclopentylpentacyclo[9.5.1.1 (3,9).1(5,15).1(7,13)]octasiloxane; 1-vinyl-3,5,7,9,11,13,15-isobutylpentacyclo[9.5.1.1(3,9).1(5,15).1 (7,13)]octasiloxane,(3-(2,2-bis(hydroxymethyl)butoxy)propyl)dimethylsiloxy-3,5,7,9,11,13,15-isobutylpentacyclo[9.5.1.1.(3,9).1(5,15).1(7,13)]octasiloxane; octa(3-hydroxy-3-methylbutyldimethylsiloxy)octasiloxane; 1-(3-amino)propyl-3,5,7,9,11,13,15-isobutylpentacyclo[9.5.1.1.(3,9).1(5,15).1(7,13)]octasiloxane; 1-(3-amino)propyl-3,5,7,9,11,13,15-isooctylpentacyclo[9.5.1.1. (3,9). 1(5,15).1 (7,13)]octasiloxane; 1,3,5,7,9,11,13,15-octaminophenylpentacyclo[9.5.1 (3,9).1(5,15).1(7,13)]octasiloxane; octa-n-phenylaminopropyl)-octasiloxane; n-methylaminopropyl-heptaisobutyl-octasiloxane; octaethylammoniumoctasiloxane chloride; 1-(4-amino)phenyl-3,5,7,9,11,13,15-cyclohexlpentacyclo[9.5.1.1(3,9).1(5,15).1(7,13)]octasiloxane; 1-(amino)phenyl-3,5,7,9,11,13,15-cyclohexlpentacyclo[9.5.1.1(3,9).1 (5,15).1(7,13)]octasiloxane; 1-(4-amino)phenyl-3,5,7,9,11,13,15-heptaisobutylpentacyclo[9.5.1.1 (3,9).1 (5,15).1(7,13)]octasiloxane; 1-(amino)phenyl-3,5,7,9,11,13,15-heptaisobutylpentacylco[9.5.1.1(3,9). 1(5,15).1 (7,13)]octasiloxane; 1-[(3-maleamic acid)propyl]-3,5,7,9,11,13,15-heptacyclohexylpentacyclo[9.5.1.1(3,9).1(5,15).1(7,13)]-octasiloxane; 1-[(3-maleamic acid)propyl]-3,5,7,9,11,13,15-heptaisobutylpentacyclo[9.5.1.1(3,9).1(5,15).1(7,13)]-octasiloxane; octamaleamic acid octasiloxane; trimethoxy-[2-(7-oxabicyclo[4.1.0]hept-3-yl)ethyl]silane, hydrolyzed; 2-[[3-(trimethoxysilyl)propoxy]methyl]-oxirane, hydrolyzed; ethyl 3,5,7,9,11,13,15-heptaethylpentacyclo[9.5.1.1(3,9).1(5,15).1(7,13)]octasiloxane-1-undecanoate; 1-(3-glycidyl)propoxy-3,5,7,9,11,13,15-isooctylpentacyclo[9.5.1.1(3,9).1(5,15).1(7,13)]octasiloxane; 3,7,14-tris {[3-(epoxypropoxy)propyl]dimethylsilyloxy}-1,3,5,7,9,11,14-heptacyclohexyltricyclo[7.3.3.1(5,11)]heptasiloxane; 3,7,14-tris {[3-(epoxypropoxy)propyl]dimethylsilyloxy}-1,3,5,7,9,11,14-heptaisobutyltricyclo[7.3.3.1(5,11)]heptasiloxane; octatrifluoropropyloctasiloxane; endo-3,7,14-trifluoropropyl-1,3,5,7,9,11,14-heptaisobutyltricyclo[7.3.3.1(5,11)]heptasiloxane; 1-chlorobenzyl-3,5,7,9,11,13,15-heptaisobutylpentacyclo[9.5.1.1 (3,9).1 (5,15).1(7,13)]octasiloxane; 1,3,5,7,9,11,13,15-octakis(1,2-dibromoethyl)-pentacyclo[9.5.1.1(3,9).1(5,15).1 (7,13)]octasiloxane; 1-[(3-maleimide)propyl]-3,5,7,9,11,13,15-heptacyclohexylpentacyclo[9.5.1.1(3,9).1(5,15).1 (7,13)]-octasiloxane; 1-[(3-maleimide)propyl]-3,5,7,9,11,13,15-heptaisobutylpentacyclo[9.5.1.1 (3,9).1 (5,15).1(7,13)]-octasiloxane; 3-(3,5,7,9,11,13,15-heptaisobutylpentacyclo[9.5.1.1 (3,9).1 (5,15).1(7,13)]octasiloxan-1-yl)propylacrylate; 3-[3,5,7,9,11,13,15-heptacyclohexylpentacyclo[9.5.1.1 (3,9).1(5,15).1(7,13)]octasiloxan-1-yl]methylmethacrylate; 3-[3,5,7,9,11,13,15-heptaisobutylpentacyclo[9.5.1.1 (3,9).1 (5,15).1(7,13)]octasiloxan-1-yl]methylmethacrylate; 3-[3,5,7,9,11,13,15-heptaethylpentacyclo[9.5.1.1 (3,9).1 (5,15).1(7,13)]octasiloxan-1-yl]methylmethacrylate; 3-[3,5,7,9,11,13,15-heptaethylpentacyclo[9.5.1.1(3,9).1(5,15).1 (7,13)]octasiloxan-1-yl]propylmethacrylate; 3-[3,5,7,9,11,13,15-heptaisooctylpentacyclo[9.5.1.1(3,9).1(5,15).1 (7,13)]octasiloxan-1-yl]methylmethacrylate; 3-(3,5,7,9,11,13,15-heptaisooctylpentacyclo[9.5.1.1 (3,9).1(5,15).1(7,13)]octasiloxan-1-yl)propylmethacrylate; 3-(3,5,7,9,11,13,15-heptaphenylpentacyclo[9.5.1.1 (3,9).1(5,15). 1(7,13)]octasiloxan-1-yl)propylmethacrylate; octasiloxa-octapropylmethacrylate; octasiloxa-octapropylacrylate; dodecaphenyldecasiloxane; octaisooctyloctasiloxane; phenylheptaisobutyloctasiloxane; phenylheptaisooctyloctasiloxane; isooctylhetpaphenyloctasiloxane; octaisobutyloctasiloxane; octamethyloctasiloxane; octaphenyloctasiloxane; octakis(tetramethylammonium)pentacyclo[9.5.1.1 (3,9).1(5,15).1(7,13)]octasiloxane 1,3,5,7,9,11,13,15-octakis(cyloxide)hydrate; octakis(trimethylsiloxy)pentacyclo[9.5.1.1 (3,9).1 (5,15).1(7,13)]octasiloxane; 3,5,7,9,11,13,15-heptaisobutylpentacyclo[9.5.1.1(3,9). 1(5,15).1 (7,13)]octasiloxane-1-butyronitrile; 1-[2-(5-norbornen-2-yl)ethyl]-3,5,7,9,11,13,15-heptaethylpentacyclo[9.5.1.1(3,9).1(7,13)]octasiloxane; 1-[2-(5-norbornen-2-yDethyl]-3,5,7,9,11,13,15-heptaisobutylpentacyclo[9.5.1.1(3,9). 1(7,13)]octasiloxane; 1-allyl-3,5,7,9,11,13,15-heptaisobutylpentacyclo[9.5.1.1(3,9). 1(7,13)]octasiloxane; 1,3,5,7,9,11,13-heptaisobutyl-15-vinylpentacyclo[9.5.1.1(3,9).1(5,15). 1(7,13)]octasiloxane; 1,3,5,7,9,11,13,15-octa[2-(3-cyclohexenyl)ethyldimethylsiloxy]pentacyclo[9.5.1.1 (3,9).1(5,15).1(7,13)]octasiloxane; 1,3,5,7,9,11,13,15-octavinylpentacyclo[9.5.1.1(3,9).1 (5,15).1(7,13)]octasiloxane; 1,3,5,7,9,11,13,15-octa[vinyldimethylsiloxy]pentacyclo[9.5.1.1 (3,9).1(5,15).1(7,13)]octasiloxane; 1,3,5,7,9,11,13,15-octakis(dimethylsilyloxy)pentacyclo[9.5.1.1 (3,9).1(5,15).1(7,13)]octasiloxane; 1,3,5,7,9,11,13,15-octahydropentacyclo[9.5.1.1(3,9).1(5,15).1 (7,13)]octasiloxane; 1-(3-mercapto)propyl-3,5,7,9,11,13,15-isobutylpentacyclo[9.5.1.1(3,9).1(5,15).1 (7,13)]octasiloxane; 1-(3-mercapto)propyl-3,5,7,9,11,13,15-isooctylpentacyclo[9.5.1.1(3,9).1(5,15).1(7,13)]octasiloxane; and the like.

Exemplary silsesquioxanes having an open cage structure include 1,3,5,7,9,11,14-heptacyclohexyltricyclo[7.3.3.1 (5, 11)]heptasiloxane-endo-3,7,14-triol;
1,3,5,7,9,11,14-heptacyclopentyltricyclo[7.3.3.1(5,11)]heptasiloxane-endo-3,7,14-triol;
1,3,5,7,9,11-octaisobutyltetracyclo[7.3.3.1(5,11)]octasiloxane-endo-3,7-diol; 1,3,5,7,9,11,14-heptaethyltricyclo[7.3.3.1(5,11)]heptasiloxane-endo-3,7,14-triol; 1,3,5,7,9,11,14-heptaisobutyltricyclo[7.3.3.1(5,11)]heptasiloxane-endo-3,7,14-triol; 1,3,5,7,9,11,14-heptaisooctyltricyclo[7.3.3.1 (5,110]heptasiloxane-endo-3,7,14-triol; 1,3,5,7,9,11,14-heptaphenyltricyclo[7.3.3.1 (5,11)]heptasiloxane-endo-3,7,14-triol; tricyclo[7.3.3.3 (3,7)]octasiloxane-5,11,14,17-tetraol-1,3,5,7,9,11,14,17-octaphenyl; 9-{dimethyl[2-(5-norbornen-2-yl)ethyl]silyloxy}-1,3,5,7,9,11,14-heptaisobutyltricyclo[7.3.3.1 5,11]heptasiloxane-1,5-diol; endo-3,7,14-tris {dimethyl[2-(5-norbornen-2-yl)ethyl]silyloxy}-1,3,5,7,9,11,14-heptaisobutyltricyclo[7.3.3.1(5,11)]heptasiloxane; [[dimethyl(trifluoromethyl)ethyl]silyloxy]heptacyclopentyltricycloheptasiloxanediol; 1,3,5,7,9,11,14-heptacyclohexyltricyclo[7.3.3.1(5,11)]heptasiloxane-3,7,14-triol; 1,3,5,7,9,11,14-heptaisobutyltricyclo[7.3.3.1(5,11)]heptasiloxane-endo-3,7,14-triol; 1,3,5,7,9,11-octacyclopentyltetracyclo[7.3.3.1(5,11)]octasiloxane-endo-3,7-diol; 1,3,5,7,9,11,14-heptaisooctyltricyclo[7.3.3.1(5,11)]heptasiloxane-endo-3,7,14-triol; endo-3,7,14-trifluoro-1,3,5,7,9,11,14-heptacyclopentyltricyclo[7.3.3.1 (5,11)]heptasiloxane; endo-3,7,14-tris{dimethyl[2-(5-norbornen-2-yl)ethyl]silyloxy}-1,3,5,7,9,11,14-heptacyclopentyltricyclo[7.3.3.1(5,11)]heptasiloxane; tris((dimethyl(trifluoromethyl)ethyl)silyloxy)heptacyclopentyltricycloheptasiloxane; 3,7,14-tris{[3-(epoxypropoxy)propyl]dimethylsilyloxy}-1,3,5,7,9,11,14-heptacyclopentyltricyclo[7.3.3.1(5,11)]heptasiloxane, and the like.

A combination of the silsesquioxanes with an open cage structure or closed cage structure can be used as the silsesquioxane in conjunction with a combination of any of the second nanoparticles.

In an embodiment, the silsesquioxane is combined with a second nanoparticle. The silsesquioxane and second nanoparticle can interact in various ways, including physical adsorption, chemisorption, and the like. In some embodiments, the silsesquioxane is bonded to the second nanoparticle. In another embodiment, the silsesquioxane and second nanoparticle are electrostatically attracted to one another. In one embodiment, the silsesquioxane can react with the second nanoparticle to form the bond therebetween. In a particular embodiment, the silsesquioxane and second nanoparticles interact via a functional group, through either bonding or electrostatics. Furthermore, any number of silsesquioxanes can be physisorbed or chemisorbed to any number of second nanoparticles, in any order or structural geometry.

In another embodiment, the silsesquioxane or second nanoparticle is bonded to another component in the nanocomposite, including the resin or reactive functional groups that may be present in the resin. Such bonding between the silsesquioxane and resin improves tethering of the silsesquioxane to the resin. In an embodiment, the silsesquioxane is bonded to the resin. In another embodiment, the second nanoparticle is bonded to the resin. In yet another embodiment, the silsesquioxane and second nanoparticles are both bonded to the resin. The second nanoparticle can have a degree of derivatization that varies from 1 functional group for every 5 carbon centers to 1 functional group for every 100 carbon centers depending on the functional group.

The resin, such as an epoxy resin, can be a monomer that forms a polymer (e.g., a thermosetting plastic), oligomer, or a polymer having a reactive functional group. The resin can include a thermoset, thermoplastic, or a combination thereof. Moreover, the nanocomposite can include a blend of polymers, copolymers, terpolymers, or combinations comprising at least one of the foregoing resins. The resin can also contain an oligomer, homopolymer, copolymer, block copolymer, alternating block copolymer, random polymer, random copolymer, random block copolymer, graft copolymer, star block copolymer, dendrimer, or the like, or a combination comprising at last one of the foregoing.

A “thermoset” solidifies when first heated under pressure, and thereafter may not melt or mold without destroying the original characteristics. Thermosetting materials can include epoxides, phenolics, melamines, ureas, polyurethanes, polysiloxanes, polymers including a suitable crosslinkable functional moiety, or a combination comprising at least one of the foregoing.

A thermoplastic has a macromolecular structure that repeatedly softens when heated and hardens when cooled. Illustrative examples of thermoplastic polymeric materials include olefin-derived polymers, for example, polyethylene, polypropylene, and their copolymers; polymethylpentane-derived polymers, for example, polybutadiene, polyisoprene, and their copolymers; polymers of unsaturated carboxylic acids and their functional derivatives, for example, acrylic polymers such as poly (alkyl acrylates), poly (alkyl methacrylate), polyacrylamides, polyacrylonitrile, and polyacrylic acid; alkenylaromatic polymers, for example polystyrene, poly-alpha-methylstyrene, polyvinyltoluene, and rubber-modified polystyrenes; polyamides, for example, nylon-6, nylon-66, nylon-11, and nylon-12; polyesters, such as, poly(alkylene dicarboxylates), e.g., poly(ethylene terephthalate) (hereinafter sometimes designated “PET”), poly(1,4-butylene terephthalate) (hereinafter sometimes designated “PBT”), poly(trimethylene terephthalate) (hereinafter sometimes designated “PTT”), poly(ethylene naphthalate) (hereinafter sometimes designated “PEN”), poly(butylene naphthalate) (hereinafter sometimes designated “PBN”), poly(cyclohexanedimethanol terephthalate), poly(cyclohexanedimethanol-co-ethylene terephthalate) (hereinafter sometimes designated “PETG”), and poly(1,4-cyclohexanedimethyl-1,4-cyclohexanedicarboxylate) (hereinafter sometimes designated “PCCD”), and poly(alkylene arenedioates); polycarbonates; co-polycarbonates; co-polyestercarbonates; polysulfones; polyimides; polyarylene sulfides; polysulfide sulfones; and polyethers such as polyarylene ethers, polyphenylene ethers, polyethersulfones, polyetherimides, polyetherketones, polyetheretherketones; or blends or copolymers thereof.

In an embodiment, the nanocomposite also includes an auxiliary filler. A auxiliary filler, as used herein, includes a reinforcing or non-reinforcing auxiliary filler. Reinforcing auxiliary fillers include, for example, silica, glass fiber, carbon fiber, or carbon black, which can be added to the nanocomposite to increase strength. Non-reinforcing auxiliary fillers such as polytetrafluoroethylene (PTFE), molybdenum disulfide (MoS₂), or graphite can be added to the nanocomposite to increase lubrication. Other auxiliary fillers, such as a carbon nanotubes, nanoclays, or the like, can be incorporated into the nanocomposite to increase the strength and elongation of the material. The auxiliary fillers can further be functionalized to include grafts or functional groups to adjust properties such as solubility, surface charge, hydrophilicity, lipophilicity, and other properties. Combinations comprising at least one of the foregoing auxiliary fillers can be used. The auxiliary filler can be present in the nanocomposite in an amount from 0.5 wt % to 70 wt %, specifically 0.5 wt % to 50 wt %, and more specifically 0.5 wt % to 25 wt %, based on the weight of the nanocomposite.

The silsesquioxane can be present in an amount from 0.1 wt % to 90 wt %, specifically 0.1 wt % to 75 wt %, and more specifically 0.1 wt % to 30 wt % based on a weight of the composition. A ratio of the weight of the silsesquioxane to that of the second nanoparticle in the nanocomposite can be from 1:500 to 500:1, specifically 1:300 to 300:1, more specifically 1:100 to 100:1, and even more specifically 1:50 to 50:1. The second nanoparticle can be present in the nanocomposite in an amount from 0.1 wt % to 80 wt %, specifically 0.1 wt % to 60 wt %, and more specifically 0.1 wt % to 20 wt %, based on a weight of the nanocomposite.

In an embodiment, a process for making the nanocomposite includes combining a resin and silsesquioxane. The silsesquioxane or resin can be dispersed in a solvent, or a solvent can be added to the combination of the silsesquioxane and resin. The solvent can be an inorganic solvent such as water, including deionized water, or buffered or pH adjusted water, mineral acid, or a combination comprising at least one of the foregoing, or an organic solvent comprising an alkane, alcohol, ketone, oils, ethers, amides, sulfones, sulfoxides, or a combination comprising at least one of the foregoing. Exemplary inorganic solvents include water, sulfuric acid, hydrochloric acid, or the like; exemplary oils include mineral oil, silicone oil, or the like; and exemplary organic solvents include alkanes such as hexane, heptane, 2,2,4-trimethylpentane, n-octane, cyclohexane, and the like; alcohols such as methanol, ethanol, propanol, isopropanol, butanol, t-butanol, octanol, cyclohexanol, ethylene glycol, ethylene glycol methyl ether, ethylene glycol ethyl ether, ethylene glycol butyl ether, propylene glycol, propylene glycol methyl ether, propylene glycol ethyl ether, and the like; ketones such as acetone, methyl-ethyl ketone, cyclohexanone methyletherketone, 2-heptanone, and the like; esters such as ethyl acetate, propylene glycol methyl ether acetate, ethyl lactate, and the like; ethers such as tetrahydrofuran, dioxane, and the like; polar aprotic solvents such as N,N-dimethylformamide, N-methylcaprolactam, N-methylpyrrolidine, dimethylsulfoxide, gamma-butyrolactone, and the like; or a combination comprising at least one of the foregoing.

Before combining the silsesquioxane and resin, the second nanoparticle, can be bonded to or mixed with the silsesquioxane. Reaction conditions include a temperature or pressure effective to bond the silsesquioxane to the second nanoparticle. In an embodiment, the temperature is 35° C. to 250° C., and specifically 25° C. to 125° C. The pressure can be less than 1 atmosphere (atm) to 10 atm, specifically 1 atm to 7 atm, and more specifically 1 atm to 3 atm. A catalyst can be added to increase the reaction rate of bonding the silsesquioxane to the second nanoparticle. In an embodiment, a silicon atom of the cage structure of the silsesquioxane is bonded directly to the second nanoparticle. In another embodiment, a functional group attached to the silsesquioxane or second nanoparticle is used to bond the silsesquioxane to the second nanoparticle. In one embodiment, the functional group is attached to the silsesquioxane prior to reaction. In another embodiment, the functional group is attached to the second nanoparticle prior to reaction. Thus, in some embodiments, a functional group intercedes between the silsesquioxane and second nanoparticle to bond the silsesquioxane to the second nanoparticle. In a further embodiment, no functional group intercedes between the silsesquioxane and second nanoparticle such that the silsesquioxane and second nanoparticle are bonded directly to one another.

According to an embodiment, the silsesquioxane and resin are dispersed with one another. The silsesquioxane is derivatized with a functional group to facilitate dispersal with the resin. In addition, the resin can be derivatized with a functional group to improve the processing with the silsesquioxane. To improve mixing, the resin and silsesquioxane can be dispersed in a solvent including inorganic solvents like water, or mineral acids such as sulfuric acid, or organic solvents including oils, alcohols and glycols, ketones such as methylethylketone (MEK), ethers such as tetrahydrofuran (THF), polar aprotic solvents such as N,N-dimethylformamide (DMF), dimethylsulfoxide (DMSO), or another solvent.

In a specific embodiment, a method for making a nanocomposite comprises combining, e.g., by blending, a resin, and 0.1 to 60 wt % of a derivatized silsesquioxane based on the weight of the composition, the derivatized silsesquioxane including functional groups comprising alkyl, alkoxy, haloakyl, cycloalkyl, heterocycloalkyl, cycloalkyloxy, aryl, aralkyl, aryloxy, aralkyloxy, ether, epoxy, ketone, heteroaryl, heteroaralkyl, alkenyl, alkynyl, amine, alkyleneamine, aryleneamine, alkenyleneamine, hydroxy, carboxyl, halogen, or a combination comprising at least one of the forgoing functional groups.

In another embodiment, the silsesquioxane can be formulated as a solution or dispersion and cast or coated, or may be mechanically dispersed in the resin. Dispersion of the silsesquioxane and the resin can be accomplished by methods such as, for example, extrusion, blending, high shear mixing, rotary mixing, three-roll milling, solution mixing, and the like. The properties of the nanocomposite can be adjusted by the selection of resin or silsesquioxane (or curing agent as below).

Rotational mixing is a mixing method in which the vessel containing the mixing components is rotated about its axis, while simultaneously processing at a fixed radius about a second rotational center. Thus, the vessel precesses to mix the composition. Mixing in this way provides high shear and elimination of bubbles, while avoiding use of agitators which can lead to a non-homogeneous composition that may be caused by, for example, different mixing zones within a mixing vessel or bubbles generated by mixing and cavitation. Use of vacuum in processing can further improve both mechanical properties and (reduced) variability by removing volatile components and any adventitious bubbles that may form during the mixing process. An example of a rotational mixer which can provide suitable mixing of the components (i.e., of the polymer and nanofiller), with or without vacuum, is a THINKY® Rotational Vacuum Mixer AR 310 (available from Thinky, Inc.).

In another embodiment, mixing by a reactive injection molding-type process can be accomplished using two or more continuous feed streams, where the silsesquioxane can be included as a component of one of the feed streams (e.g., where the resin is an epoxy prepared using different feed streams, the silsesquioxane can be included in an epoxy containing stream or in a separate stream as a suspension in a solvent). Mixing in such systems is accomplished by the flow within the mixing zone at the point of introduction of the components.

According to an embodiment, the silsesquioxane is combined with the resin, and then the silsesquioxane is bonded to the resin. In a non-limiting embodiment, the silsesquioxane and resin are combined, and a crosslinking reaction is initiated. In another embodiment, the silsesquioxane is introduced after initiating the crosslinking reaction. In an embodiment, the silsesquioxane is mixed with the resin such that a gradient in the concentration of the silsesquioxane with respect to the resin is present in an article containing the nanocomposite.

In an embodiment, the resin is an epoxy resin that is a monomer, oligomer, or polymer containing an epoxy functional group, which reacts with the silsesquioxane or curing agent to form a reaction product in the nanocomposite. In a particular embodiment, the function group is a glycidyl group. According to an embodiment, the epoxy resin herein includes an average epoxy functionality of 2 or more epoxy groups per molecule, specifically 3 or more epoxy groups, and more specifically 4 or more epoxy groups. In some embodiments, the epoxy resin has an average of from 2 to 3 epoxy groups per molecule. The epoxy resin can be a saturated or unsaturated aliphatic, cycloaliphatic, aromatic, or heterocyclic compound that has an epoxy group. The epoxy resin can be substituted with a substituent group, e.g., a halogen, hydroxyl, ether, alkyl, and the like. Moreover, the epoxy resin can be a monoepoxide, diepoxide, polyepoxide, or a combination thereof. The epoxy resin can be prepared, e.g., by reaction of diglycidyl ethers of dihydric phenols with dihydric phenols or by reaction of dihydric phenols with epichlorohydrin. Glycidyl ether groups for reaction with a bisphenol include, e.g., butyl glycidyl ether, C8 to C14 aliphatic monoglycidyl ether, cresyl glycidyl ether, neopentyl glycol diglycidyl ether, or a combination thereof. Alternatively, the epoxy resin can be prepared by reaction of a hydroxyl, carboxyl, or amine containing compound with epichlorohydrin, optionally in the presence of a basic catalyst such as a metal hydroxide, e.g., sodium hydroxide. Another route to obtain an epoxy resin is by reaction of a carbon-carbon double bond in an olefin with a peroxide, e.g., a peroxyacid.

According to an embodiment, the epoxy resin includes, for example, a diglycidyl ether of a polyhydric phenol such as resorcinol, catechol, hydroquinone, bisphenol A, bisphenol AP, bisphenol F, bisphenol K, tetramethylbisphenol; diglycidyl ether of an aliphatic glycol or polyether glycol such as the diglycidyl ether of a C₂ to C₂₄ alkylene glycol, poly(ethylene oxide), or poly(propylene oxide) glycol; polyglycidyl ether of phenol-formaldehyde novolac resin; alkyl-substituted phenol-formaldehyde resin (epoxy novalac resins); phenol-hydroxybenzaldehyde resin; cresol-hydroxybenzaldehyde resin; dicyclopentadiene-phenol resin; dicyclopentadiene-substituted phenol resin; or a combination comprising at least one of the foregoing.

In an embodiment, the epoxy resin is a multifunctional epoxy resin that cures to form a nanocomposite with high chemical resistance. Multifunctional epoxy resins include, for example: bisphenol epoxy resins (i.e., resins containing a bisphenol core structure with a pendant epoxy functional group), glycidyl ether epoxy resins, or aliphatic epoxy resins. Bisphenol epoxy resins can be derived from bisphenols such as 2,2-bis(4-hydroxyphenyl)propane (bisphenol A); 1,1-bis(4-hydroxyphenyl)-1-phenyl-ethane (bisphenol AP); 2,2-bis(4-hydroxyphenyl)hexafluoropropane (bisphenol AF); 2,2-bis(4-hydroxyphenyl)butane (bisphenol B); bis-(4-hydroxyphenyl)diphenylmethane (bisphenol BP); 2,2-bis(3-methyl-4-hydroxyphenyl)propane (bisphenol C); bis(4-hydroxyphenyl)-2,2-dichlorethylene (bisphenol D); 1,1-bis(4-hydroxyphenyl)ethane (bisphenol E); bis(4-hydroxydiphenyl)methane (bisphenol F); 2,2-bis(4-hydroxy-3-isopropyl-phenyl)propane (bisphenol G); 1,3-bis(2-(4-hydroxyphenyl)-2-propyl)benzene (bisphenol M); bis(4-hydroxyphenyl)sulfone (bisphenol S); 1,4-bis(2-(4-hydroxyphenyl)-2-propyl)benzene (bisphenol P); 5,5′-(1-methylethyliden)-bis[1,1′-(bisphenyl)-2-ol]propane (bisphenol PH); 3,3,5-trimethylcyclohexanone 1,1-Bis(4-hydroyphenyl)-3,3,5-trimethyl-cyclohexane (bisphenol TMC); 1,1-bis(4-hydroxyphenyl)-cyclohexane (bisphenol Z), and the like.

Exemplary diglycidyl ethers of dihydric phenols include bisphenol A, bisphenol K, bisphenol F, bisphenol S, bisphenol AD, or a combination thereof. Such epoxy resins are commercially available from Dow Chemical Company under the trade name DER 317, DER 331, DER 364, DER 383, DER 661, DER 662, DER 664 DER 667, and the like. The epoxy resin can be substituted with a group such as a halogen, e.g. bromine, attached to a phenyl ring of a bisphenol moiety which is commercially available from Dow Chemical Company under the trade names DER 542 or DER 560. Commercially available diglycidyl ethers of polyglycols include DER. 732 or DER 736 available from Dow Chemical Company. Epoxy novolac resins include cresol-formaldehyde novolac epoxy resins, phenol-formaldehyde novolac epoxy resins and bisphenol A novolac epoxy resins, including those available commercially as DEN 354, DEN 431, DEN 438, or DEN 439, from Dow Chemical Company.

In another embodiment, the epoxy resin is a cycloaliphatic epoxide. Such cycloaliphatic epoxides include a saturated carbon ring having an epoxy oxygen bonded to two adjacent carbon atoms of the carbon ring. Exemplary cycloaliphatic epoxy resins include (3,4-epoxycyclohexyl-methyl)-3,4-epoxy-cyclohexane carboxylate; bis-(3,4-epoxycyclohexyl) adipate; vinylcyclohexene monoxide; 3-(1,2-epoxyethyl)-7-oxabicyclo heptane; hexanedioic acid, bis(7-oxabicyclo heptylmethyl) ester; 2-(7-oxabicyclohept-3-yl)-spiro(1,3-dioxa-5,3′-(7)-oxabicyclo heptane); methyl-3,4-epoxycyclohexane carboxylate; 3-cyclohexenylmethyl-3-cyclohexenylcarboxylate diepoxide; 2-(3,4-epoxy)cyclohexyl-5,5-spiro-(3,4-epoxy)cyclohexane-m-dioxane; 3,4-epoxycyclohexylalkyl-3,4-epoxycyclohexanecarboxylate; 3,4-epoxy-6-methylcyclohexylmethyl-3,4-epoxy-6-methylcyclohexanecarboxylate; vinyl cyclohexanedioxide, bis(3,4-epoxycyclohexylmethyl)adipate; bis(3,4-epoxy-6-methylcyclohexylmethyl)adipate, exo-exo bis(2,3-epoxycyclopentyl)ether; endo-exo bis(2,3-epoxycyclopentyl)ether; 2,2-bis(4-(2,3-epoxypropoxy)cyclohexyl)propane; 2,6-bis(2,3-epoxypropoxycyclohexyl-p-dioxane); 2,6-bis(2,3-epoxypropoxy)norbornene; diglycidylether of linoleic acid dimer; limonene dioxide; 2,2-bis(3,4-epoxycyclohexyl)propane; dicyclopentadiene dioxide; 1,2-epoxy-6-(2,3-epoxypropoxy)-hexahydro-4,7-methanoindane; p-(2,3-epoxy)cyclopentylphenyl-2,3-epoxypropylether; 1-(2,3-epoxypropoxy)phenyl-5,6-epoxyhexahydro-4,7-methanoindane; o-(2,3-epoxy)cyclopentylphenyl-2,3-epoxypropyl ether); 1,2-bis(5-(1,2-epoxy)-4,7-hexahydromethanoindanoxyl)ethane; cyclopentenylphenyl glycidyl ether; cyclohexanediol diglycidyl ether; butadiene dioxide; dimethylpentane dioxide; diglycidyl ether; 1,4-butanedioldiglycidyl ether; diethylene glycol diglycidyl ether; dipentene dioxide; diglycidyl hexahydrophthalate; 5,10-dioxatricyclo[7.1.0.04,6]decane; and the like. In a specific embodiment, the cycloaliphatic epoxy resin is 3-cyclohexenylmethyl-3-cyclohexenylcarboxylate diepoxide.

Exemplary aliphatic epoxy resins include epoxy resins that contain an aliphatic group, including C4 to C20 aliphatic or polyglycol chains such as butadiene dioxide, dimethylpentane dioxide, diglycidyl ether, 1,4-butanedioldiglycidyl ether, diethylene glycol diglycidyl ether, dipentene dioxide, and the like. Commercially available aliphatic epoxy resins are, e.g., DER 732 and DER 736 from Dow Chemical Company.

Other commercially available epoxy resins include, for example Epikote 807, Epikote 815, Epikote 825, Epikote 827, Epikote 828, Epikote 190P, and Epikote 191P (manufactured by Yuka Shell Epoxy Co., Ltd.); Epikote 1004, Epikote 1256, YX8000 (manufactured by Japan Epoxy Co., Ltd.); Araldiate 8615, Araldite CY177, Araldite CY184 (manufactured by Huntsman Intl. LLC); Clloxide 2021P, EHPE-3150 (manufactured by Daicel Chemical Industries, Ltd.); Techmore VG3101L (manufactured by Mitsui & Co., Ltd.); Epikote 871, Epikote 872, Epikote 4250, Epikote 4275 (manufactured by Japan Epoxy Resin Co., Ltd.); Epiclon TSR-960, Epiclon TSR-601, Epiclon TSR-250-80BX, Epiclon 1600-75×(manufactured by DIC. Inc.); YD-171, YD-172, YD-175×75, PG-207, ZX-1627, YD-716 (manufactured by Nippon Steel Chemical Co., Ltd.); Adeka Resin EP-4000, Adeka Resin EP-4000S, Adeka Resin EPB 1200 (manufactured by Adeka Corp.); EX-832, EX-841, EX-931, Denarex R-45EPT (manufactured by Nagase ChemteX Corp.); BPO-20E, BPO-60E (manufactured by New Japan Chemical Co.); Epolight 400E, Epolight 400P, Epolight 3002 (manufactured by Kyoeisha Chemical Co., Ltd.); SR-8EG, SR-4PG (manufactured by Sakamoto Pharmaceutical Co.); Heloxy 84, Heloxy 505 (manufactured by Hexion Specialty Chemicals, Inc.); SB-20G, IPU-22G (manufactured by Okamura Oil Mill, Ltd.); Epolead PB3600 (manufactured by Daicel Chemical Industries, Ltd.); EPB-13 (manufactured by Nippon Soda Co., Ltd.); and the like.

In a specific embodiment, the epoxy resin is triglycidyl-p-aminophenol, bis[4-(2,3-epoxypropoxy)phenyl]propane, N,N,N′,N′-tetraglycidyl-4,4′-diaminodiphenylmethane, butanedioldiglycidyl ether, or a combination comprising at least one of the foregoing.

In an embodiment, a curing agent is added to the silsesquioxane and resin to form a composition. The curing agent can be a hardener, accelerator, catalyst, curative, initiator, and the like, or a combination comprising at least one of the foregoing. It is believed that the curing agent reacts with functional groups located within the composition such as epoxy groups in various ways that may include crosslinking, adding to a polymer backbone, or capping a polymer. The curing agent includes an amine, amide, phenol, thiol, carboxylic acid, anhydride, alcohol, or a combination comprising at least one of the foregoing. These curing agents can enhance properties such as heat and chemical resistance of the resulting nanocomposite. The curing agent can be selected based on the resin or silsesquioxane as well as the desired properties of the nanocomposite.

The amine curing agent includes a primary, secondary, or tertiary amine, ammonium salt, and the like. Exemplary amine curing agents are 1,2-diaminoethane, 1,3-cyclohexanedimethanamine, 2,2′-dimethyl-4,4′ methylenebis(cyclohexylamine), 2,4,6-tris(dimethylaminomethyl)phenol, 2-methylpentamethylenediamine, 2-piperazin-1-ylethylamine, 3-aminomethyl-3,5,5-trimethylcyclohexylamine, 3-aminopropyldimethylamine, 4,4′-diaminodiphenylmethane, 4,4′-methylenebis(cyclohexylamine), benzyldimethylamine, bis[(dimethylamino)methyl]phenol, 1,3-benzenedimethanamine, N(3-dimethylaminopropyl)-1,3-propylenediamine, octahydro-4,7-methano-1H-indenedimethylamine, tetraethylenepentamine, isophoronediamine, triethylenetetraamine, diethylenetriamine, aminoethylpiperazine, 1,2-diaminopropane, 1,3-diaminopropane, 2,2-dimethylpropylenediamine, 1,4-diaminobutane, 1,6-diaminohexane, 1,7-diaminoheptane, 1,8-diaminooctane, 1,9-diaminonane, 1,12-diaminododecane, 4-azaheptamethylenediamine, N,N′-bis(3-aminopropyl)butane-1,4-diamine, cyclohexanediamine, dicyandiamine, diamide diphenylmethane, diamide diphenylsulfonic acid (amine adduct), 4,4′-methylenedianiline, diethyltoluenediamine, m-phenylene diamine, melamine formaldehyde, tetraethylenepentamine, 3-diethylaminopropylamine, 3,3′-iminobispropylamine, 2,4-bis(p-aminobenzyl)aniline, tetraethylenepentamine, 3-diethylaminopropylamine, 2,2,4-trimethylhexamethylenediamine, 2,4,4-trimethylhexamethylenediamine, 1,2-trimethylhexamethylenediamine, 1,3-diaminocyclohexane, 1,4-diamino-3,6-diethylcyclohexane, 1,2-diamino-4-ethylcyclohexane, 1,4-diamino-3,6-diethylcyclohexane, 1-cyclohexyl-3,4-dimino-cyclohexane, 4,4′-diaminodicyclohexylmethane, 4,4′-diaminodicyclohexylpropane, 2,2-bis(4-aminocyclohexyl)propane, 3,3′-dimethyl-4,4′-diaminodicyclohexylmethane, 3-amino-1-cyclohexaneaminopropane, 1,3-bis(aminomethyl)cyclohexane, 1,4-bis(aminomethyl)cyclohexane, m-xylylendiamine, p-xylylendiamine, and the like.

Exemplary anhydride curing agents include maleic anhydride, tetrahydrophthalic anhydride, hexahydrophthalic acid, methyltetrahydrophthalic anhydride, methylhexahydrophthalic anhydride, 1,2-cyclohexanedicarboxylic anhydride, bicyclo[2.2.1]hept-5-ene-2,3-dicarboxylic anhydride, methylbicyclo[2.2.1]hept-5-ene-2,3-dicarboxylic anhydride, phthalic anhydride, pyromellitic dianhydride, hexahydrophthalic anhydride, dodecenylsuccinic anhydride, dichloromaleic anhydride, chlorendic anhydride, tetrachlorophthalic anhydride, trimellitic anhydride, hexahydrotrimellitic anhydride, methylnadic anhydride, hydro methylnadic anhydride, dodecenyl succinic anhydride, hexahydropyromellitic dianhydride, benzophenonetetracarboxylic dianhydride, styrene-maleic anhydride copolymers, dodecyl succinic anhydride, and the like.

Exemplary isocyanate curing agents include toluene diisocyanate, methylene diphenyldiisocyanate, hydrogenated toluene diisocyanate, hydrogenated methylene diphenyldiisocyanate, polymethylene polyphenylene polyisocyanates, isophorone diisocyanate, and the like.

Thiol curing agents include polythiol or polymercaptan compounds. In an embodiment, the thiol curing agent is an alkyl polysulfide, thiuram disulfide, or amine polysulfide. Some non-limiting examples of the thiol curing agent are 4,4′-dithiomorpholine, dithiodiphosphorodisulfides, diethyldithiophosphate polysulfide, alkyl phenol disulfide, tetramethylthiuram disulfide, 4-morpholinyl-2-benzothiazole disulfide, dipentamethylenethiuram hexasulfide, and caprolactam disulfide. Additional exemplary thiol curing agents include aliphatic thiols such as methanedithiol, propanedithiol, cyclohexanedithiol, 2-mercaptoethyl-2,3-dimercapto-succinate, 2,3-dimercapto-1-propanol(2-mercaptoacetate), diethylene glycol bis(2-mercaptoacetate), 1,2-dimercaptopropyl methyl ether, bis(2-mercaptoethyl)ether, trimethylolpropane tris(thioglycolate), pentaerythritol tetra(mercaptopropionate), pentaerythritol tetra(thioglycolate), ethyleneglycol dithioglycolate, trimethylolpropane tris(beta-thiopropionate), tris-mercaptan derivative of tri-glycidyl ether of propoxylated alkane, or dipentaerythritol poly(beta-thiopropionate); halogen-substituted derivatives of aliphatic thiols; aromatic thiols such as di-, tri- or tetra-mercaptobenzene, bis-, tris- or tetrakis(mercaptoalkyl)benzene, dimercaptobiphenyl, toluenedithiol, or naphthalenedithiol; halogen-substituted derivatives of aromatic thiols; heterocyclic ring-containing thiols such as amino-4,6-dithiol-sym-triazine, alkoxy-4,6-dithiol-sym-triazine, aryloxy-4,6-dithiol-sym-triazine, or 1,3,5-tris(3-mercaptopropyl) isocyanurate; halogen-substituted derivatives of heterocyclic ring-containing thiols; thiol compounds having at least two mercapto groups and containing sulfur atoms in addition to the mercapto groups such as bis-, tris- or tetra(mercaptoalkylthio)benzene, bis-, tris- or tetra(mercaptoalkylthio)alkane, bis(mercaptoalkyl) disulfide, hydroxyalkylsulfidebis(mercaptopropionate), hydroxyalkylsulfidebis(mercaptoacetate), mercaptoethyl ether bis(mercaptopropionate), 1,4-dithian-2,5-diolbis(mercaptoacetate), thiodiglycolic acid bis(mercaptoalkyl ester), thiodipropionic acid bis(2-mercaptoalkyl ester), 4,4-thiobutyric acid bis(2-mercaptoalkyl ester), 3,4-thiophenedithiol, bismuththiol or 2,5-dimercapto-1,3,4-thiadiazol; and the like.

Exemplary phenol curing agents include hydroquinone, catechol, resorcinol, phloroglucinol, pyrogallol, 1,6-dihydroxy naphthalene, 2,7-dihydroxy naphthalene, 2,6-dihydroxy naphthalene, 1,2,4-trihydroxybenzene, 1,3-dihydroxy naphthalene, 1,4-dihydroxy naphthalene, 1,5-dihydroxy naphthalene, 1,7-dihydroxy naphthalene, 2,3-dihydroxy naphthalene, 1,2-dihydroxy naphthalene, 2-methylresorcinol, 5-methylresorcinol, hexahydroxybenzene, 1,8,9-trihydroxyanthracene, 3-methyl-pyrocatecho, methyl-hydroquinon, 4-methyl-pyrocatecho, 4-benzylresorcinol, 1,1′-bis(2-naphthol), 4,4′-bisphenol, bis(4-hydroxyphenyl)sulfone, and 4-bromoresorcinol, 4,4′-butylidenebis(6-tert-butyl-3-m-cresol), 4-tert-butylcatechol, 2,2′-bisphenol, 4,4′-dihydroxydiphenylmethane, tert-butylhydroquinone, 1,3-bis(4-hydroxyphenoxy)benzene, 1,4-bis(3-hydroxyphenoxy)benzene, 1,1-bis(4-hydroxylphenyl)cyclohexane, bis(4-hydroxyl-3,5-dimethylphenyl)sulfone, 9,9-bis(4-hydroxyphenyl)fluorine), 9,9-bis(4-hydroxyl-3-methylphenyl)fluorine, 4-tert-butyl calix[8]arene, 4-tert-butyl calix[5]arene, 4-tert-butylsulfonyl calix[4]arene, calix[8]arene, calix[4]arene, calix[6]arene, and 4-tety-butyl calix[6]arene, 2,5-bis(1,1,3,3,-tetramethylbutyl)hydroquinone, 2,6-bis[(2-hydroxyl-5-methylphenol)methyl]-4-methylphenol, 1,1-bis(3-cyclohexyl-4-hydroxylphenol)cyclohexane, 1,1-bis(4-hydroxyl-3-methylphenol)cyclohexane, hexestrol, 2′,4′-dihydroxyacetophenone, anthrarufin, chrysazin, 2,4-dihydroxybenzaldehyde, 2,5-dihydroxybenzaldehyde, 3,4-dihydroxybenzaldehyde, ethyl 3,4-dihydroxyaminobenzoate, 2,4-dihydroxybenzophenone, 2,2′-dihydroxy-4,4′-dimethoxy-benzophenone, 4,4′-dihydroxybenzophenone, 4-ethylresorcinol, and phenylhydroquinone, 2,2′-dihydroxy-4-methoxybenzophenone, 2,2′-dihydroxybenzophenone, methyl 2,6-dihydroxyaminobenzoate, 2,3-dihydroxybenzaldehyde, octafluoro-4,4′-bisphenol, 3′,6′-dihydroxybenzoylnorbornene, 2,4′-dihydroxydiphenylmethane, 2′,5′-dihydroxyacetophenone, 3′,5′-dihydroxyacetophenone, 2,4-dihydroxyaminobenzoate, 2-hydroxyethyl-4,4′-dihydroxydiphenyl etherdihydroxydiphenyl ether, 2,2′-dihydroxydiphenyl ether, methyl 3,5-dihydroxyaminobenzoate, 1,4-dihydroxy-2-naphthoate, 3′,4′-dihydroxyacetophenone, 2,4′-dihydroxydiphenyl sulfone, 3,4′-dihydroxybenzyl alcohol, 3,5-dihydroxybenzyl alcohol, 2,4′-dihydroxybenzophenone, 2,6′-dimethyl hydroquinone, 2′,4′-dihydroxypropiophenone, 4,4′-dihydrxytetraphenylmethane, methyl 3,4-dihydroxyphenylacetate, 2,5-dimethylresorcinol, 2-(3,4-dihydroxyphenyl)ethanol, 4,4′-ethylidene bis-phenol, 3,3′-ethylenedioxydiphenol, 4-fluorocatechol, ethyl gallate, methyl gallate, propyl gallate, isoamyl gallate, hexadecyl gallate, dodecyl gallate, stearyl gallate, butyl gallate, isobutyl gallate, n-octyl-4-hexylresorcinol gallate, 4,4′-(2-hydroxybenzilidene)bis(2,3,6-trimethylphenol), 4,4′-methylene-bis-(2,6-di-tert-butylphenol), 2,2′-methylene-bis(6-tert-butyl-4-ethyl phenol), 2,2′-methylene-bis(6-tert-butyl-4-cresol), methoxyhydroquinone, 4,4′-(.alpha.-methylbenzal)bisphenol, 4,4′-methylene-bis(2,6-dimethylphenol), 2,2′-methylene-bis(4-methylphenol), 5-methoxyresorcinol, 2,2′-methylene-bis[6-(2-hydroxy-5-methylbenzyl)-p-cresol, 4,4′-methylene-bis(2-methylphenol), methyl 2,4-dihydroxyaminobenzoate, 2,2′-methylene-bis(6-cyclohexyl-p-cresol), methyl 3,4-dihydroxyaminobenzoate, and 2,5-dihydroxyaminobenzoate, 2,2′,4,4′-tetrahydroxybenzophenone, 2,4,4′-trihydroxybenzophenone, 5-methylpyrogallol, 2′,4′,6′-trihydroxypropiophenone, 2,3,4-trihydroxybenzophenone, 2′,3′,4′-trihydroxyacetophenone, 1,1,1-tris(4-hydroxyphenol)ethane, 2,3′,4,4′-tetrahydroxybenzophenone, 4,4′,4″-trihydroxytriphenylmethane, 2,3,4,4′-tetrahydroxybenzophenone, 2,3,4,4′-tetrahydroxydiphenylmethane, 5,5′,6,6′-tetrahydroxy-3,3,3′,3′-tetramethyl-1,1′-spirobiindane, 2,4,5-trihydroxybenzaldehyde, 6,6′,7,7′-tetrahydroxy-4,4,4′4′-tetramethylspirobicromane, tetrafluoro-hydroquinone, 2,3,4-trihydroxybenzaldehyde, 2,2-bis(4-hydroxyphenyl)propane, 2,2-bis(4-hydroxyphenyl)hexafluoropropane, 2,2-bis(2-hydroxy-5-biphenyl)propane, 2,2-bis(3-cyclohexyl-4-hydroxyphenyl)propane, 2,2-bis(3-sec-butyl-4-hydroxyphenyl)propane, 2,2-bis(4-hydroxy-3,5-dimethylphenyl)propane, 2,2-bis(4-hydroxy-3-isopropylphenyl)propane, 2,2-bis(4-hydroxy-3-methylphenyl)propane, and the like.

Other curing agents include boron trihalide amine adducts of amines such as monoethanolamine, diethylamine, dioctylmethylamine, triethylamine, pyridine, benzylamine, benzyldimethyl amine, and the like. Additional curing agents include phosphine compounds, such as tributylphosphine, triphenylphosphine, tris(dimethoxyphenyl)phosphine, tris(hydroxypropyl)phosphine and tris(cyanoethyl)phosphine; phosphonium salts, such as tetraphenylphosphonium tetraphenylborate, methyltributylphosphonium tetraphenylborate and methyltricyanoethyl phosphonium tetraphenylborate; and the like.

A solvent also can be added to the composition (e.g., the resin, silsesquioxane, and curing agent). The solvent is a material in which the resin or curing agent is soluble (either fully or partially), at the temperature at which the resin and curing agent are combined. In an embodiment, the solvent is not reactive with the resin or curing agent under the reactions conditions, such as polymerization. The solvent can have a boiling point that is equal to or greater than the temperature employed to conduct the reaction. Suitable solvents include, for example, glycol ethers such as ethylene glycol methyl ether and propylene glycol monomethyl ether; glycol ether esters such as ethylene glycol monomethyl ether acetate and propylene glycol monomethyl ether acetate; poly(ethylene oxide) ethers and poly(propylene oxide) ethers; polyethylene oxide ether esters and polypropylene oxide ether esters; amides such as N,N-dimethylformamide; aromatic hydrocarbons benzene, toluene and xylene; aliphatic hydrocarbons; cyclic ethers; halogenated hydrocarbons; alcohols, ethers, or acetates such as 1-methoxy-2-propanol, methoxy propanol acetate, butyl acetate, methoxyethyl ether, methanol, ethanol, isopropanol, and ethyleneglycol; ethylcellosolve; methylethyl ketone; cyclohexanone; cellosolves such as ethyl acetate, cellosolve acetate, butyl cellosolve acetate, carbitol acetate, and butyl carbitol acetate; or a combination comprising at least one of the foregoing. The solvent can be present in an amount from 0.1 wt % to 70 wt %, specifically 1 wt % to 40 wt %, and more specifically 1 wt % to 20 wt %, based on the weight of the composition.

In the composition, a total amount of the silsesquioxane and curing agent can be from 1 wt % to 80 wt %, specifically 1 wt % to 70 wt %, and more specifically 1 wt % to 50 wt %, based on a weight of the composition. The silsesquioxane can be present in the composition in an amount from 1 wt % to 60 wt %, specifically 1 wt % to 50 wt %, and more specifically 1 wt % to 30 wt %, based on the weight of the composition. The curing agent can be present in the composition in an amount from 0.05 wt % to 60 wt %, specifically 0.5 wt % to 40 wt %, and more specifically 0.5 wt % to 30 wt %, based on the weight of the composition. The resin can be present in the composition in an amount from 30 wt % to 99 wt %, specifically 40 wt % to 99 wt %, and more specifically 50 wt % to 99 wt %, based on the weight of the composition. In some embodiments, the amount of the resin is adjusted to correspond to a molar amount of another component of the composition such as the silsesquioxane, curing agent, or a functional group thereof, e.g., an amine group attached to the silsesquioxane or curing agent. In a particular embodiment, the a molar ratio of a number of moles of an epoxy functional group of the epoxy resin to the sum of the number of moles of the silsesquioxane and curing agent is from 1:1 to 100:1, specifically 1:1 to 50:1, and more specifically 1:1 to 10:1.

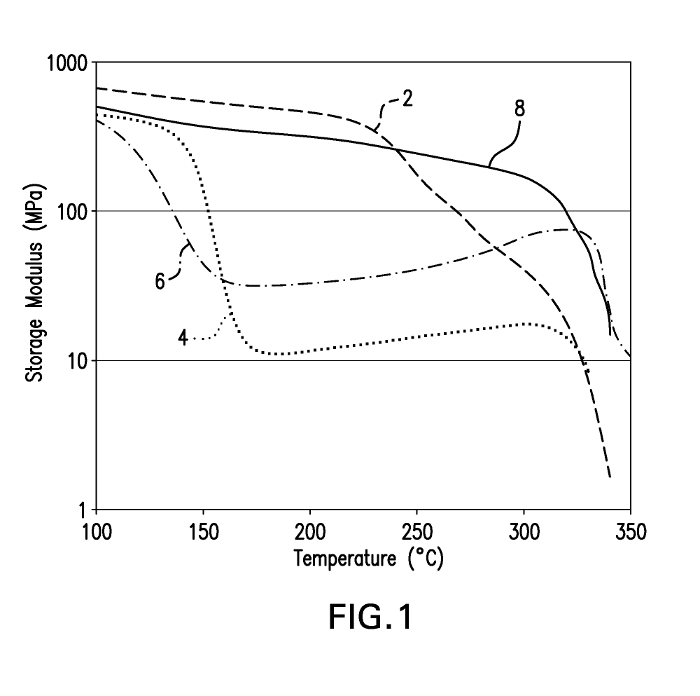

The relative amount of silsesquioxane, resin, and curing agent in the composition can determine the properties of the nanocomposite. As shown in FIG. 1, the storage modulus for a composite of an epoxy resin reacted with a first amount of a curing agent is plotted as dashed curve 2. Addition of extra curing agent (a second amount, greater than the first amount) to the epoxy resin decreases both the storage modulus and glass transition temperature as indicated by dotted curve 4. Alternatively, combining a silsesquioxane with an epoxy resin and first amount of the curing agent also decreases the storage modulus and glass transition temperature of the nanocomposite as indicated by dashed-dot curve 6. However, as shown by solid curve 8, a combination of epoxy resin, silsesquioxane, and curing agent in an appropriate proportion increases the glass transition temperature and also increases the storage modulus in a temperature range that is greater than the glass transition temperature for any of the nanocomposites represented by curves 2, 4, and 6.

In an embodiment, the relative weight amount of the resin to the curing agent in the composition is less than 2:1, i.e., the weight of the resin in the composition is less than half that of the curing agent. In an embodiment, the ratio of the weight of the resin to curing agent is from 0.1:1 to 1.9:1, specifically, 0.1:1 to 1.8:1, more specifically 0.1:1 to 1.6:1, even more specifically 0.1:1 to 1.4:1, and further more specifically 0.1:1 to 1.2:1. In another embodiment, the ratio of the weight of the silsesquioxane to curing agent is from 0.1:1 to 1.5:1, specifically, 0.1:1 to 1.3:1, more specifically 0.1:1 to 1.1:1, even more specifically 0.1:1 to 0.9.:1, and further more specifically 0.1:1 to 0.8:1

In another embodiment, the pressure and temperature can be controlled during reaction of the composition. In some embodiments, the composition is heated to a temperature from 20° C. to 300° C., specifically 50° C. to 275° C., and more specifically, 75° C. to 250° C. The pressure can be from 1 atm to 10 atm, specifically 1 atm to 7 atm, and more specifically 1 atm to 3 atm. In an embodiment, the reaction between the silsesquioxane, resin, or curing agent is moderated by selection of the temperature or a temperature program that includes a temperature ramp, temperature soak period, or a combination thereof.

According to an embodiment, the silsesquioxane and resin are combined with a curing agent. The composition is held at room temperature for 24 hours to allow formation of the reaction product (e.g., bonds between silsesquioxane, resin, or curing agent). Alternatively, the temperature can be increased to, e.g., 180° C. and maintained there for 3 hours, as an example. In another embodiment, the silsesquioxane, resin, and curing agent can be disposed in an mold (e.g., a compression mold) to form the nanocomposite.

The nanocomposite and articles made from the nanocomposite have advantageous properties. The nanocomposite is a high temperature composite with an advantageous decomposition and flame retardant properties. In an embodiment, the nanocomposite has a thermal decomposition temperature equal to or greater than 150° C., specifically 200° C., and more specifically 350° C. The nanocomposite also has a char content equal to or greater than 35 wt %, specifically 25 wt %, and more specifically 10 wt %, based on a weight of the nanocomposite, at a temperature greater than the thermal decomposition temperature of the nanocomposite. The nanocomposite has a time to ignition equal to or greater than 30 seconds. The nanocomposite has a self-extinguish time equal to or less than 20 seconds. Moreover, the nanocomposite is resistant to solvent diffusion through the nanocomposite.

The nanocomposite and articles herein has a higher storage modulus at a temperature greater than the glass transition temperature of the neat resin. As used herein, “neat polymer” or “neat reason” refers to polymer or resin or combination of resins, with or without additives, that is cured but does not have an added nanoparticle, e.g., silsesquioxane, herein. The storage modulus increase of the nanocomposite (as compared with the neat polymer) can be equal to or greater than 10 times that of the neat polymer, specifically 5 times, and more specifically 2 times at a temperature greater than the glass transition temperature of the neat polymer. In addition, the nanocomposite has a glass transition temperature equal to or greater than 100° C., specifically 235° C., and more specifically 300° C. In an embodiment, the nanocomposite has a glass transition temperature that is at least 10° C. greater than that of the resin, specifically 50° C., and more specifically 90° C.

Properties of an article of the nanocomposite are an outcome of the reaction product of the composition containing resin, silsesquioxane, and curing agent. In an embodiment, the total amount of the silsesquioxane and curing agent is from 1 wt % to 70 wt %, specifically 1 wt % to 50 wt %, and mores specifically 1 wt % to 30 wt %, based on a total weight of the resin, silsesquioxane, and curing agent. The methods and nanocomposite herein can be used as a coating or part, for example, an adhesive, a barrier coating, a bag for an electro submersible pump (ESP), gear, housing, fiber optic cable, logging tool cable, and the like. In addition, items such as a filter, membrane, conduit, partition, and the like can be prepared from the nanocomposite. In a specific embodiment, an optical fiber is disposed in the nanocomposite (which is in a fluid or powder state), and the nanocomposite is allowed to harden or cure on the surface of the optical fiber, forming a nanocomposite coated fiber optic cable. In another embodiment, the silsesquioxane, resin, and curing agent are introduced into a mold, which is heated to react the composition under compression. The nanocomposite thus formed can be removed subsequently from the mold to produce, for example, an article that can be further machined.

Articles may be formed from the nanocomposite prepared by the above method. As the nanocomposite herein has beneficial mechanical and thermal properties, articles prepared from the nanocomposite will have advantageous mechanical properties, reliability, and environmental stability. Thus, in an embodiment, an article comprises the nanocomposite. The nanocomposite may be used to form all or a portion of an article such as a filter. In some embodiments, an article of the nanocomposite can be useful in a downhole application, such as for example a filter, sand consolidation, packer element, blow out preventer element, torsional spring of a sub surface safety valve, submersible pump motor protector bag, sensor protector, sucker rod, O-ring, T-ring, gasket, sucker rod seal, pump shaft seal, tube seal, valve seal, seal for an electrical component, insulator for an electrical component, seal for a drilling motor, or the like.

The methods herein are further illustrated by the following non-limiting examples.

### Example 1

In a planetary mixer, 12 g of an epoxy resin containing triglycidyl-p-aminophenol, bis[4-(2,3-epoxypropoxy)phenyl]propane, N,N,N′,N′-tetraglycidyl-4,4′-diaminodiphenylmethane, and butanedioldiglycidyl ether was combined with 2 g of octaglycidyloctasiloxane. The epoxy resin and octaglycidyloctasiloxane were mixed and 6 g of 4,4′-methylenebis(2-methyl-cyclohexamine). After mixing from 5 to 30 minutes, 1 g of additional 4,4′-methylenebis(2-methyl-cyclohexamine) was added to the composition. The temperature was maintained at 24 hours for curing. Thereafter, the temperature was increased to 180° C. for 3 hours while mixing. The mixer was cooled to room temperature to obtain a nanocomposite.

### Example 2

In a planetary mixer, 10.7 g of an epoxy resin containing triglycidyl-p-aminophenol, bis[4-(2,3-epoxypropoxy)phenyl]propane, N,N,N′,N′-tetraglycidyl-4,4′-diaminodiphenylmethane, and butanedioldiglycidyl ether was combined with 4 g of octaglycidyloctasiloxane. The epoxy resin and octaglycidyloctasiloxane were mixed and 5.3 g of 4,4′-methylenebis(2-methyl-cyclohexamine). After mixing from 5 to 30 minutes, 2 g of additional 4,4′-methylenebis(2-methyl-cyclohexamine) was added to the composition. The temperature was maintained at 24 hours for curing. Thereafter, the temperature was increased to 180° C. for 3 hours while mixing. The mixer was cooled to room temperature to obtain a nanocomposite.

### Example 3

In a planetary mixer, 9.3 g of an epoxy resin containing triglycidyl-p-aminophenol, bis[4-(2,3-epoxypropoxy)phenyl]propane, N,N,N′,N′-tetraglycidyl-4,4′-diaminodiphenylmethane, and butanedioldiglycidyl ether was combined with 6 g of octaglycidyloctasiloxane. The epoxy resin and octaglycidyloctasiloxane were mixed and 4.7 g of 4,4′-methylenebis(2-methyl-cyclohexamine). After mixing from 5 to 30 minutes, 3 g of additional 4,4′-methylenebis(2-methyl-cyclohexamine) was added to the composition. The temperature was maintained at 24 hours for curing. Thereafter, the temperature was increased to 180° C. for 3 hours while mixing. The mixer was cooled to room temperature to obtain a nanocomposite.

### Comparative Example 1

In a planetary mixer, 12 g of an epoxy resin containing triglycidyl-p-aminophenol, bis[4-(2,3-epoxypropoxy)phenyl]propane, N,N,N′,N′-tetraglycidyl-4,4′-diaminodiphenylmethane, and butanedioldiglycidyl ether was combined with 6 g of 4,4′-methylenebis(2-methyl-cyclohexamine). After mixing from 5 to 30 minutes, 1 g of additional 4,4′-methylenebis(2-methyl-cyclohexamine) was added to the composition. The temperature was maintained at 24 hours for curing. Thereafter, the temperature was increased to 180° C. for 3 hours while mixing. The mixer was cooled to room temperature to obtain a nanocomposite.

### Comparative Example 2

In a planetary mixer, 10.7 g of an epoxy resin containing triglycidyl-p-aminophenol, bis[4-(2,3-epoxypropoxy)phenyl]propane, N,N,N′,N′-tetraglycidyl-4,4′-diaminodiphenylmethane, and butanedioldiglycidyl ether was combined with 5.3 g of 4,4′-methylenebis(2-methyl-cyclohexamine). After mixing from 5 to 30 minutes, 2 g of additional 4,4′-methylenebis(2-methyl-cyclohexamine) was added to the composition. The temperature was maintained at 24 hours for curing. Thereafter, the temperature was increased to 180° C. for 3 hours while mixing. The mixer was cooled to room temperature to obtain a nanocomposite.

### Comparative Example 3

In a planetary mixer, 9.3 g of an epoxy resin containing triglycidyl-p-aminophenol, bis[4-(2,3-epoxypropoxy)phenyl]propane, N,N,N′,N′-tetraglycidyl-4,4′-diaminodiphenylmethane, and butanedioldiglycidyl ether was combined with 4.7 g of 4,4′-methylenebis(2-methyl-cyclohexamine). After mixing from 5 to 30 minutes, 3 g of additional 4,4′-methylenebis(2-methyl-cyclohexamine) was added to the composition. The temperature was maintained at 24 hours for curing. Thereafter, the temperature was increased to 180° C. for 3 hours while mixing. The mixer was cooled to room temperature to obtain a nanocomposite.

### Comparative Example 4

In a planetary mixer, 12 g of an epoxy resin containing triglycidyl-p-aminophenol, bis[4-(2,3-epoxypropoxy)phenyl]propane, N,N,N′,N′-tetraglycidyl-4,4′-diaminodiphenylmethane, and butanedioldiglycidyl ether was combined with 6 g of 4,4′-methylenebis(2-methyl-cyclohexamine). The temperature was maintained at 24 hours for curing. Thereafter, the temperature was increased to 180° C. for 3 hours while mixing. The mixer was cooled to room temperature to obtain a nanocomposite.

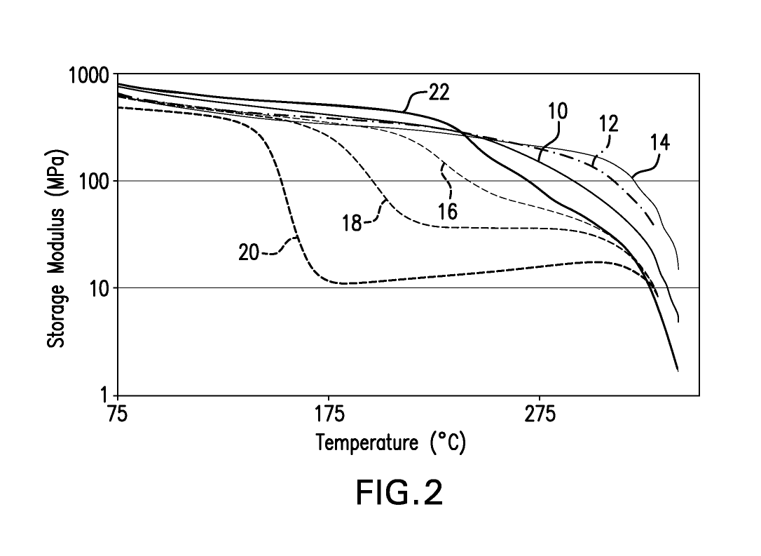

FIG. 2 shows a graph of the storage modulus versus temperature for the nanocomposites of Examples 1-4 and Comparative Examples 1-3, labeled respectively as curves 10-22 in FIG. 2. The nanocomposite of Comparative Example 4 (curve 22) has no silsesquioxane or extra curing agent. An increasing amount of more curing agent (curves 16-20) added to the epoxy resin without any silsesquioxane leads to a decreasing glass transition temperature and storage modulus. After introducing the silsesquioxane with extra curing agent (as compared with Comparative Example 4), the glass transition temperature increases with both increasing amounts of silsesquioxane and curing agent, as indicated by curves 10-14, Examples 1-3 respectively. Thus, the glass transition temperature and storage modulus can be controlled by selection of the relative amounts of the resin, curing agent, and silsesquioxane.

While one or more embodiments have been shown and described, modifications and substitutions may be made thereto without departing from the spirit and scope of the invention. Accordingly, it is to be understood that the present invention has been described by way of illustrations and not limitation. Embodiments herein are can be used independently or can be combined.

All ranges disclosed herein are inclusive of the endpoints, and the endpoints are independently combinable with each other. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” It should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity). The conjunction “or” is used to link objects of a list or alternatives and is not disjunctive, rather the elements can be used separately or can be combined together under appropriate circumstances.

What is claimed is:

1. A process for preparing a nanocomposite, the process comprising:
combining a resin and silsesquioxane;
introducing a curing agent to the resin and silsesquioxane to form a composition; and
forming a reaction product of the composition to prepare the nanocomposite,
wherein a total amount of the silsesquioxane and curing agent in the composition is from 1 wt % to 70 wt %, based on a weight of the composition.

2. The process of claim 1, further comprising heating the composition from 75° C. to 250° C.

3. The process of claim 1, wherein the resin comprises an epoxy, phenolic, melamine, urea, polyurethane, polysiloxane, polyethylene, polypropylene, polybutadiene, polyisoprene, acrylic, polyacrylamide, polyacrylonitrile, polyacrylic acid, alkenylaromatic polymer, polyamide, polyester, polycarbonate, polysulfone, polyimide, polyarylene sulfide, polysulfide sulfone, polyether, or a combination comprising at least one of the foregoing.

4. The process of claim 3, wherein the resin is the epoxy.

5. The process of claim 1, wherein the silsesquioxane includes a functional group attached to a silicone atom of a cage structure of the silsesquioxane.

6. The process of claim 5, wherein the functional group attached to the silicon atom comprises an amine, thiol, alcohol, aldehyde, alkyl, alkenyl, alkynyl alkoxy, haloakyl, cycloalkyl, heterocycloalkyl, cycloalkyloxy, aryl, aralkyl, aryloxy, aralkyloxy, ether, epoxy, ketone, heteroaryl, heteroaralkyl, alkyleneamine, aryleneamine, alkenyleneamine, hydroxy, carboxyl, halogen, hydrogen, or a combination comprising at least one of the foregoing.

7. The process of claim 5, wherein the cage structure of the silsesquioxane includes from 4 to 20 silicon atoms.

8. The process of claim 1, wherein the curing agent comprises an amine, amide, phenol, thiol, carboxylic acid, anhydride, alcohol, or a combination comprising at least one of the foregoing.

9. The process of claim 8, wherein the curing agent is the amine which includes, 2-diaminoethane, 1,3-cyclohexanedimethanamine, 2,2′-dimethyl-4,4′ methylenebis(cyclohexylamine), 2,4,6-tris(dimethylaminomethyl)phenol, 2-methylpentamethylenediamine, 2-piperazin-1-ylethylamine, 3-aminomethyl-3,5,5-trimethylcyclohexylamine, 3-aminopropyldimethylamine, 4,4′-diaminodiphenylmethane, 4,4′-methylenebis(cyclohexylamine), benzyldimethylamine, bis[(dimethylamino)methyl]phenol, 1,3-benzenedimethanamine, N(3-dimethylaminopropyl)-1,3-propylenediamine, octahydro-4,7-methano-1H-indenedimethylamine, tetraethylenepentamine, isophoronediamine, triethylenetetraamine, diethylenetriamine, aminoethylpiperazine, 1,2-diaminopropane, 1,3-diaminopropane, 2,2-dimethylpropylenediamine, 1,4-diaminobutane, 1,6-diaminohexane, 1,7-diaminoheptane, 1,8-diaminooctane, 1,9-diaminonane, 1,12-diaminododecane, 4-azaheptamethylenediamine, N,N′-bis(3-aminopropyl)butane-1,4-diamine, cyclohexanediamine, dicyandiamine, diamide diphenylmethane, diamide diphenylsulfonic acid (amine adduct), 4,4′-methylenedianiline, diethyltoluenediamine, m-phenylene diamine, melamine formaldehyde, tetraethylenepentamine, 3-diethylaminopropylamine, 3,3′-iminobispropylamine, 2,4-bis(p-aminobenzyl)aniline, tetraethylenepentamine, 3-diethylaminopropylamine, 2,2,4-trimethylhexamethylenediamine, 2,4,4-trimethylhexamethylenediamine, 1,2-trimethylhexamethylenediamine, 1,3-diaminocyclohexane, 1,4-diamino-3,6-diethylcyclohexane, 1,2-diamino-4-ethylcyclohexane, 1,4-diamino-3,6-diethylcyclohexane, 1-cyclohexyl-3,4-dimino-cyclohexane, 4,4′-diaminodicyclohexylmethane, 4,4′-diaminodicyclohexylpropane, 2,2-bis(4-aminocyclohexyl)propane, 3,3′-dimethyl-4,4′-diaminodicyclohexylmethane, 3-amino-1-cyclohexaneaminopropane, 1,3-bis(aminomethyl)cyclohexane, 1,4-bis(aminomethyl)cyclohexane, m-xylylendiamine, p-xylylendiamine, or a combination comprising at least one of the foregoing.

10. The process of claim 1, wherein the silsesquioxane is present in the composition in an amount from 1 wt % to 60 wt %, based on the weight of the composition.

11. The process of claim 1, wherein the curing agent is present in the composition in an amount from 0.05 wt % to 60 wt %, based on the weight of the composition.

12. The process of claim 1, wherein the resin is present in the composition in an amount from 30 wt % to 99 wt %, based on the weight of the composition.

13. The process of claim 1, further comprising adding a filler to the composition, the filler comprising graphene, nanographite, silica, glass fiber, carbon fiber, carbon black, polytetrafluoroethylene, molybdenum disulfide, carbon nanotubes, nanoclay, or a combination comprising at least one of the foregoing.

14. The process of claim 1, wherein the nanocomposite has a thermal decomposition temperature equal to or greater than 150° C.

15. The process of claim 1, wherein nanocomposite has a glass transition temperature equal to or greater than 100° C.

16. The process of claim 1, wherein the glass transition temperature of the nanocomposite is at least 10° C. greater than that of the polymer.

17. The process of claim 1, wherein the nanocomposite has a storage modulus at least 2 times greater than the resin cured without the silsesquioxane.

18. A process for preparing an article, the process comprising:
combining an epoxy resin and silsesquioxane;
introducing a curing agent to the epoxy resin and silsesquioxane to form a composition; and
reacting the epoxy resin, silsesquioxane, and curing agent to form the nanocomposite, wherein a molar ratio of a number of moles of an epoxy functional group of the epoxy resin to the sum of the number of moles of the silsesquioxane and curing agent is from 1:1 to 100:1.

19. The process of claim 18, wherein the epoxy functional group is a glycidyl group.

20. An article comprising a reaction product of:
an epoxy resin;
a silsesquioxane; and
a curing agent,
wherein a total amount of the silsesquioxane and curing agent is from 1 wt % to 70 wt %, based on a total weight of the epoxy resin, silsesquioxane, and curing agent.
